(19) United States
(12) Patent Application Publication
(10) Pub. No.: US 2020/0054083 A1
(43) Pub. Date: Feb. 20, 2020

(54) COMBINED SEAT COVER AND LEISURE COAT

(71) Applicant: SURFLO CO., LTD., Suwon-si (KR)

(72) Inventor: Yong Hui PARK, Yongin-si (KR)

(73) Assignee: SURFLO CO., LTD., Suwon-si, Gyeonggi-do (KR)

(21) Appl. No.: 16/372,641

(22) Filed: Apr. 2, 2019

(30) Foreign Application Priority Data
Aug. 16, 2018 (KR) 10-2018-0095414

(51) Int. Cl. A41D 15/04; B60N 2/60; A41D 3/02

(52) U.S. Cl. CPC A41D 15/04; A41D 3/02; B60N 2/6054

(57) ABSTRACT

A combined seat cover and leisure coat includes a coat body that includes front and back panels and covers and protects an upper body and a part of a lower body of a wearer or covers a seat pad and a back support of a seat, a hood that covers and protects the wearer's head or is mounted on a headrest of the seat, a folding part that is provided on a lower portion of the back panel of the coat body so as to be foldable and covers one area of the seat pad of the seat, a pair of sleeves that cover and protect the wearer's arms or are bound to the back support of the seat, and fastening units that are provided on the pair of sleeves and fasten the pair of sleeves bound to the back support of the seat.

### CROSS-REFERENCE TO RELATED APPLICATIONS

A claim for priority under 35 U.S.C. § 119 is made to Korean Patent Application No. 10-2018-0095414 filed Aug. 16, 2018 in the Korean Intellectual Property Office, the entire contents of which are hereby incorporated by reference.

### BACKGROUND

Embodiments of the inventive concept described herein relate to a combined seat cover and leisure coat, and more particularly, relate to a combined seat cover and leisure coat that is mounted on a seat of a vehicle after a leisure activity of a wearer to prevent contamination of the seat.

Recently, with the activation of leisure sports, many people have been interested in the leisure sports and have enjoyed the leisure sports.

Water leisure activities such as windsurfing, wakeboarding, jet skiing, and water skiing are widely practiced as a kind of leisure sports.

A leisure coat is usually worn to prevent a body drenched in water from being exposed to the air, or to prevent a drop in body temperature due to cold wind, during a water leisure activity.

Meanwhile, in order to prevent a sudden drop in body temperature, a water leisure activist usually gets in a vehicle immediately after water leisure activities. Among the water leisure activities, a leisure activity on the surface of the sea is frequently practiced in an unspecified beach, and in the three seasons except the summer, there is no facility for washing the body or taking off a wet suit (a surfing suit or a diving suit) worn for the leisure activity on the surface of the sea. Therefore, the water leisure activist may sit on a seat of the vehicle while drenched in water, and hence the seat of the vehicle may be wetted or contaminated.

Accordingly, a leisure coat that is mounted as a seat cover for a vehicle under normal circumstances to prevent contamination in the vehicle, is easy to wash, and is easily detached from a seat and worn to maintain a body temperature and protect a body during a leisure activity is required, in which the contamination includes contamination that may occur in the vehicle in everyday life and contamination that may occur when a user drenched in water gets in the vehicle.

### SUMMARY

Embodiments of the inventive concept provide a combined seat cover and leisure coat that is worn by a wearer to maintain the body temperature and protect the body during a leisure activity and that is mounted on a seat of a vehicle to prevent contamination of the seat when the wearer gets in the vehicle.

According to an exemplary embodiment, a combined seat cover and leisure coat includes a coat body that includes a front panel and a back panel and that covers and protects an upper body and a part of a lower body of a wearer or covers a seat pad and a back support of a seat, a hood that extends from an upper portion of the back panel of the coat body and that covers and protects the wearer's head or is mounted on a headrest of the seat, a folding part that is provided on a lower portion of the back panel of the coat body so as to be foldable and that covers one area of the seat pad of the seat, a pair of sleeves that are connected to the coat body and that cover and protect the wearer's arms or are bound to the back support of the seat, and fastening units that are provided on the pair of sleeves and that fasten the pair of sleeves bound to the back support of the seat.

The fastening units may be any one of female and male hooks, a Velcro fastener, a double-sided tape, a snap button, and a zipper.

The pair of sleeves may have pockets formed thereon, in which the fastening units are received.

The combined seat cover and leisure coat may further include an anti-slip pad provided on the folding part to bring the folding part into close contact with the seat pad of the seat to prevent slipping of the folding part on the seat pad of the seat.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a front view illustrating a combined seat cover and leisure coat according to an embodiment of the inventive concept;

FIG. 2 is a view illustrating a state in which a front panel of the combined seat cover and leisure coat according to the embodiment of the inventive concept is unfolded;

FIG. 3 is a view illustrating a state in which a folding part of FIG. 2 is unfolded;

FIG. 4 is a view illustrating a state in which the combined seat cover and leisure coat according to the embodiment of the inventive concept is mounted on a seat of a vehicle; and

FIG. 5 is a rear view of FIG. 4.

### DETAILED DESCRIPTION

The above and other aspects, features, and advantages of the inventive concept will become apparent from the following description of embodiments given in conjunction with the accompanying drawings. However, the inventive concept is not limited to the embodiments disclosed herein and may be implemented in various different forms. Herein, the embodiments are provided to provide complete disclosure of the inventive concept and to provide thorough understanding of the inventive concept to those skilled in the art to which the inventive concept pertains.

Terms used herein are only for description of embodiments and are not intended to limit the inventive concept. As used herein, the singular forms are intended to include the plural forms as well, unless context clearly indicates otherwise. It will be further understood that the terms “comprise” and/or “comprising” specify the presence of stated features, components, and/or operations, but do not preclude the presence or addition of one or more other features, components, and/or operations. In addition, like numerals will denote like components throughout the specification, and the meaning of “and/or” includes each mentioned item and every combination of mentioned items. It will be understood that, although the terms first, second, etc. may be used herein to describe various components, these components should not be limited by these terms. These terms are only used to distinguish one component from another component. Thus, a first component discussed below could be termed a second component without departing from the teachings of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should not be interpreted in an idealized or overly formal sense unless expressly so defined herein.

Hereinafter, the inventive concept will be described in detail with reference to the accompanying drawings.

Prior to description of the inventive concept, it should be noted that the spirit and scope of the inventive concept is applicable to a normal leisure coat used in general leisure activities as well as a surf coat widely used in water leisure activities such as surfing.

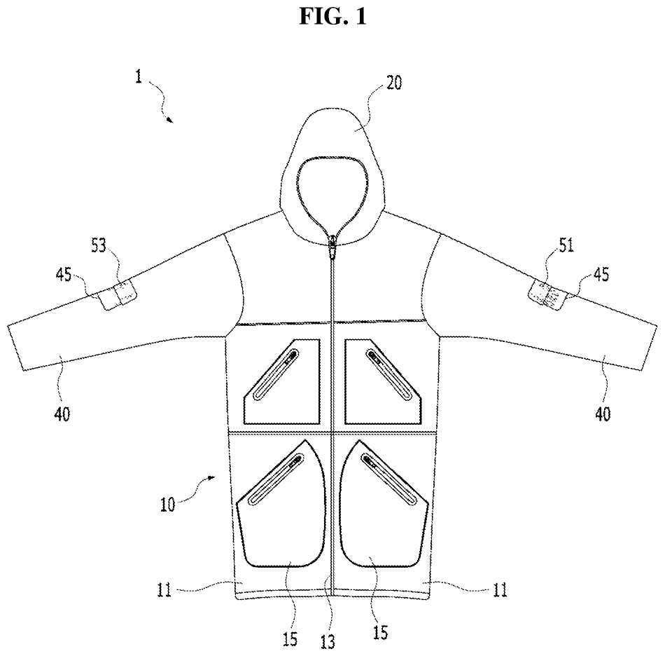

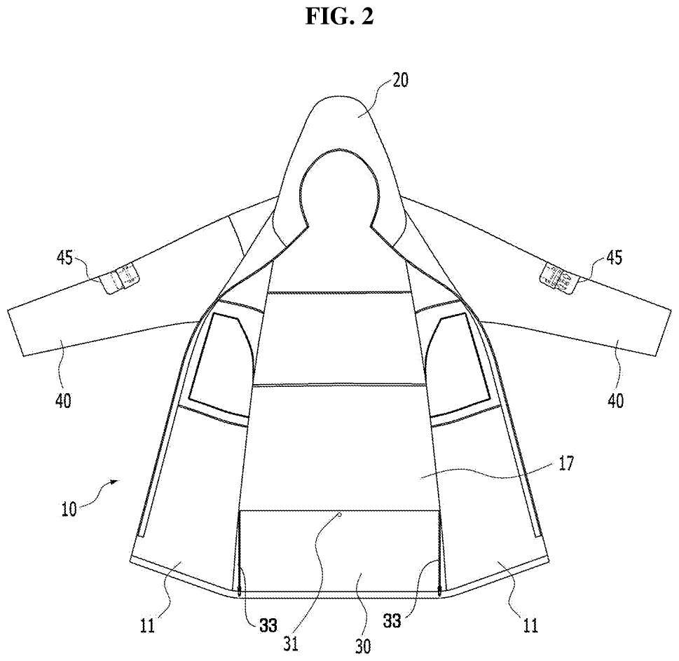

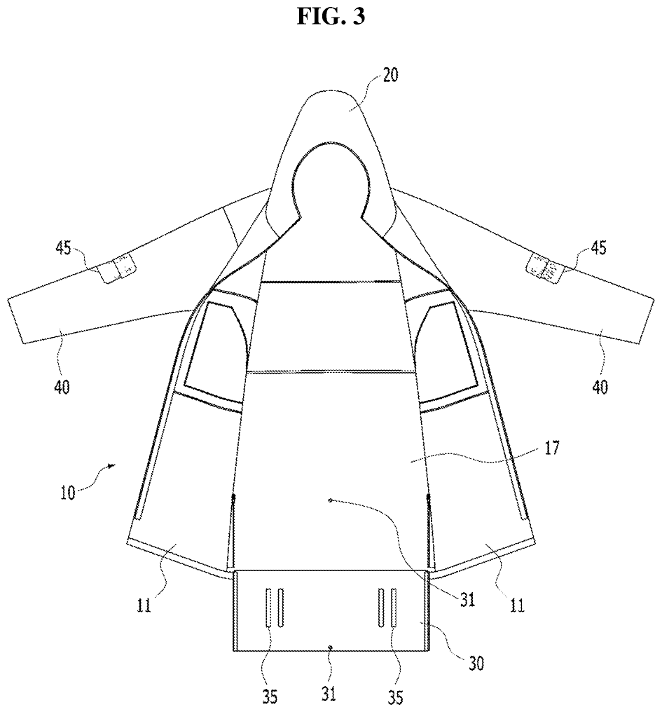

FIGS. 1 to 3 illustrate a combined seat cover and leisure coat according to an embodiment of the inventive concept.

As illustrated in FIGS. 1 to 3, the combined seat cover and leisure coat 1 according to the embodiment of the inventive concept includes a coat body 10, a hood 20, a folding part 30, a pair of sleeves 40, and fastening units.

The coat body 10 includes a front panel 11 and a back panel 17.

The coat body 10 is worn by a wearer to cover and protect an upper body and a part of a lower body of the wearer.

The front panel 11 is divided into left and right sides to enable the wearer to fasten the coat body 10 around the wearer's body. In this embodiment, the front panel 11, which is divided into the left and right sides, is illustrated as being fastened by a zipper 13. However, the front panel 11 may be fastened by a button instead of the zipper 13.

Furthermore, the front panel 11 may have a plurality of pockets 15 in which to receive objects.

The coat body 10 may have a length sufficient to cover the wearer's hips, may have a length sufficient to cover the wearer's knees, or may have a length sufficient to cover parts below the wearer's knees.

For example, when mounted on a seat 100 of a vehicle, the coat body 10 covers a seat pad 101 and a back support 105 of the seat 100.

The hood 20 extends from an upper portion of the back panel 17 of the coat body 10 and covers and protects the wearer's head.

The hood 20, when mounted on the seat 100 of the vehicle, is mounted on a headrest 111 of the seat 100.

The folding part 30 has a predetermined length and width and is provided on a lower portion of the back panel 17 of the coat body 10 so as to be foldable.

Opposite end portions of the folding part 30 and portions in contact with an inner fabric of the back panel 17 of the coat body 10 are firmly fastened by zippers 33.

As described above, the folding part 30 is fastened by the zippers 33, and therefore the wearer may put large portable objects hard to receive in the pockets 15, which are formed on the front side of the coat body 10, into the space between the folding part 30 and the back panel 17 when the wearer has the combined seat cover and leisure coat 1 on.

The folding part 30 may have a snap button 31 in the central area thereof and may be fastened to the back panel 17 of the coat body 10 by the snap button 31. Accordingly, the folding part 30 may be prevented from being separated from the back panel 17 of the coat body 10 when the wearer has the combined seat cover and leisure coat 1 on.

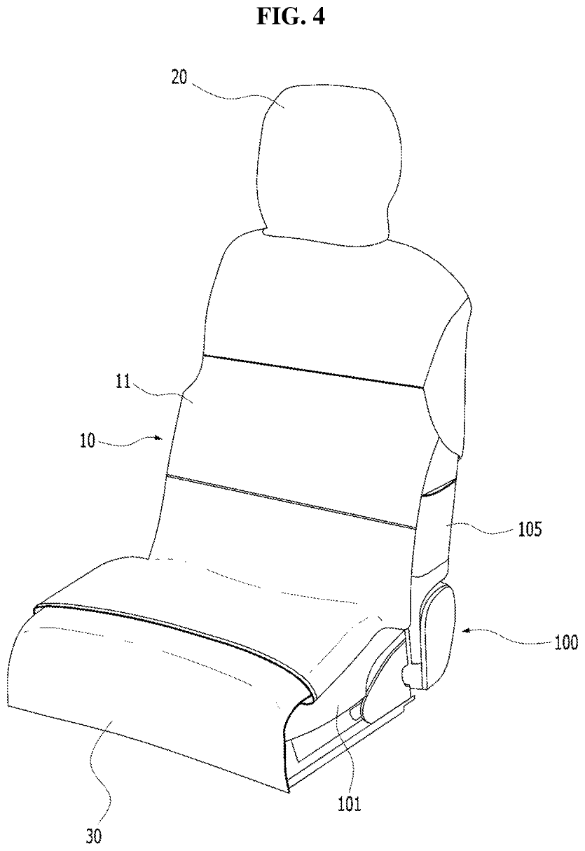

When mounted on the seat 100 of the vehicle, the folding part 30 is unfolded from the back panel 17 of the coat body 10 and then covers one area of the seat pad 101 of the seat 100, for example, the front of the seat pad 101 as illustrated in FIG. 4.

Anti-slip pads 35 are provided on one area of the folding part 30 that faces the back panel 17 of the coat body 10.

When the folding part 30 is mounted on the seat 100 of the vehicle, the anti-slip pads 35 are brought into close contact with the seat pad 101 of the seat 100 to prevent the coat body 10 from slipping from the seat pad 101.

The pair of sleeves 40 are connected between the front panel 11 and the back panel 17 of the coat body 10 to cover and protect the wearer's arms.

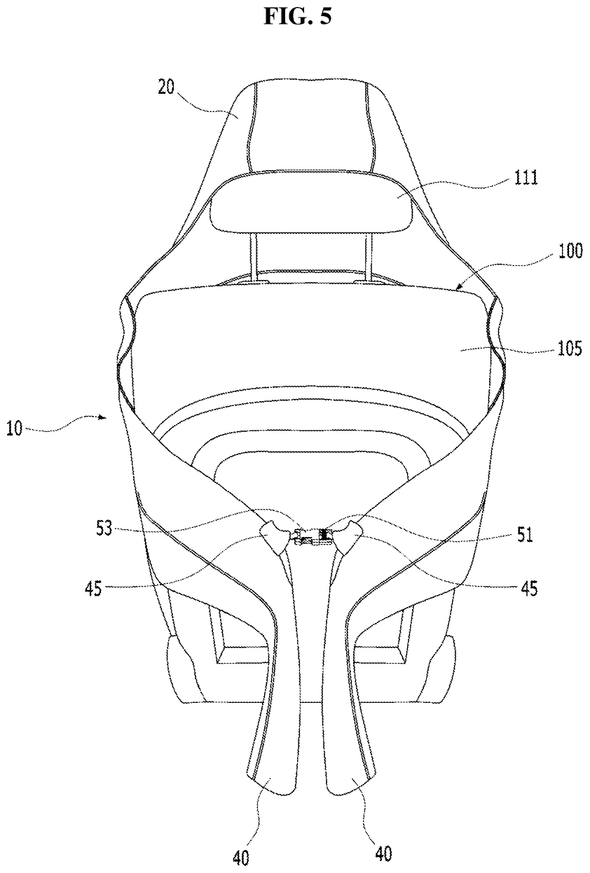

The pair of sleeves 40, when mounted on the seat 100 of the vehicle, are bound to the back support 105 of the seat 100 as illustrated in FIG. 5.

The fastening units 51 and 53 are provided on the pair of sleeves 40 and fasten the pair of sleeves 40 bound to the back support 105 of the seat 100.

The pair of female and male hooks 51 and 53 are combined together to prevent the coat body 10 from being twisted or separated from the seat 100 due to a user's motion.

Any one of the pair of sleeves 40 has the male hook 51, and the other has the female hook 53 to which the male hook 51 is hook coupled.

The male hook 51 and the female hook 53 are received in pockets 45 provided on the corresponding sleeves 40, respectively.

As described above, the pockets 45 are formed on the pair of sleeves 40, and therefore the male hook 51 and the female hook 53 are not exposed to the outside when the wearer has the combined seat cover and leisure coat 1 on, so that the combined seat cover and leisure coat 1 has an appealing appearance.

In this embodiment, the female and male hooks 51 and 53 are used as the fastening units. However, the fastening units are not limited thereto, and any one of a Velcro fastener, a double-sided tape, a snap button, and a zipper may be used as the fastening units.

The combined seat cover and leisure coat 1 according to the embodiment of the inventive concept is preferably made of neoprene that has high resistance to rain and wind due to its excellent waterproof and windproof functions and is light in weight and from which sand can be easily shaken even though it has the sand thereon.

The coat body 10 may have an inner fabric integrally formed of a fleece-lined heat-insulating material, or a fabric made of a fleece-lined heat-insulating material may be formed to be attachable to and detachable from the coat body 10, to improve the ability to keep warm.

Due to this configuration, the wearer has the combined seat cover and leisure coat 1 on to maintain the body temperature and protect the body during leisure activities.

When the wearer wants to mount the combined seat cover and leisure coat 1 according to the embodiment of the inventive concept on the seat 100 of the vehicle, the wearer unfolds the folding part 30 from the coat body 10 and mounts the hood 20 on the headrest 111 of the seat 100 to cause the inner fabric of the hood 20 to face the headrest 111 as illustrated in FIG. 4.

Next, the wearer covers the seat pad 101 and the back support 105 with the coat body 10 to cause the inner fabric of the coat body 10 to face the back support 105 and the seat pad 101 and brings the folding part 30 into close contact with the front of the seat pad 101.

Then, as illustrated in FIG. 5, the wearer locates the pair of sleeves 40 behind the back support 105, pulls the female and male hooks 51 and 53 out of the pockets 45 of the pair of sleeves 40, and hook couples the female and male hooks 51 and 53 to fasten the pair of sleeves 40 and bind the pair of sleeves 40 to the back support 105 of the seat 100, thereby completely mounting the combined seat cover and leisure coat 1 on the seat 100 of the vehicle.

When the combined seat cover and leisure coat 1 is completely mounted on the seat 100 of the vehicle as described above, the seat 100 may be prevented from being wetted or contaminated by water even though a vehicle occupant drenched in water sits on the seat 100 of the vehicle after water leisure activities.

According to the inventive concept, the combined seat cover and leisure coat may be worn by the wearer to maintain the body temperature and protect the body during a leisure activity and may be mounted on the seat of the vehicle to prevent contamination of the seat when the wearer gets in the vehicle.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A combined seat cover and leisure coat comprising:
a coat body including a front panel and a back panel, wherein the coat body covers and protects an upper body and a part of a lower body of a wearer or covers a seat pad and a back support of a seat;
a hood extending from an upper portion of the back panel of the coat body, wherein the hood covers and protects the wearer's head or is mounted on a headrest of the seat;
a folding part provided on a lower portion of the back panel of the coat body so as to be foldable, wherein the folding part covers one area of the seat pad of the seat;
a pair of sleeves connected to the coat body, wherein the pair of sleeves cover and protect the wearer's arms or are bound to the back support of the seat; and
fastening units provided on the pair of sleeves, wherein the fastening units fasten the pair of sleeves bound to the back support of the seat.

2. The combined seat cover and leisure coat of claim 1, wherein the fastening units are any one of female and male hooks, a Velcro fastener, a double-sided tape, a snap button, and a zipper.

3. The combined seat cover and leisure coat of claim 1, wherein the pair of sleeves have pockets formed thereon, in which the fastening units are received.

4. The combined seat cover and leisure coat of claim 1, further comprising:
an anti-slip pad provided on the folding part to bring the folding part into close contact with the seat pad of the seat to prevent slipping of the folding part on the seat pad of the seat.
